(19) United States
(12) Patent Application Publication
(10) Pub. No.: US 2003/0197851 A1
(43) Pub. Date: Oct. 23, 2003

(54) Photomask and method of manufacturing the same

(76) Inventor: Satoshi Aoyama, Tokyo (JP)

Correspondence Address: Burns, Doane, Swecker & Mathis, L.L.P., P.O. Box 1404, Alexandria, VA, 22313-1404, US

(21) Appl. No.: 10/273,146

(22) Filed: Oct. 18, 2002

(30) Foreign Application Priority Data
Apr. 22, 2002 (JP) 2002-119561

(51) Int. Cl. G03B 27/62

(52) U.S. Cl. 355/75; 355/30; 355/53; 430/5; 430/20; 430/30

(57) ABSTRACT

There is described a photomask having a substrate having a pattern formed thereon, a pellicle film which opposes a surface of the substrate and is stretched while remaining spaced a predetermined interval away from the substrate, and a frame which retains the pellicle film and closes a space between the pellicle film and the photomask substrate. The frame has an opening, and the opening is provided with a cover section capable of closing the opening. The pellicle film is affixed to the substrate of the frame in an inactive gas, and the internal space of the photomask is sealed with the cover section.

### BACKGROUND OF THE INVENTION

1. Field of the Invention

The invention relates to a photomask. More specifically, the invention relates to the structure of a photomask on which a transfer pattern to be used for exposure is formed.

2. Background Art

At the time of fabrication of a semiconductor circuit, a photomask which is to act as an original plate is usually produced on the basis of data pertaining to a circuit pattern design. Subsequently, by use of exposure systems, such as a stepper and a scanner, a pattern formed on the photomask is transferred, through exposure, onto a wafer coated with a resist. As a result of the wafer having been subjected to development processing after exposure, a resist pattern is formed on the wafer. Processing pertaining to steps of etching a thin film and ion implantation is performed through use of the resist pattern, thereby forming a semiconductor circuit on the wafer.

FIG. 6 is a schematic cross-sectional view showing a photomask to be used as an original plate at the time of transfer of a pattern onto a wafer.

As shown in FIG. 6, a photomask 400 is provided with a reticle 2. A circuit pattern to be transferred onto a wafer is formed on the reticle 2 through use of a glass substrate 4 and chrome 6 provided thereon. A frame 8 is provided around the reticle 2. A pellicle film 10 is stretched across the frame 8 so as to oppose the surface of the reticle 2 having the chrome 6 provided thereon. An opening 12 is formed in the frame 8, and a filter 16 is affixed to the opening 12. The filter 16 is a bundle of polymeric fibers.

The pellicle film 10 prevents adhesion of extraneous matter to the reticle 2, thereby inhibiting transfer of the extraneous matter adhering to the reticle 2 onto a wafer through exposure, which would otherwise cause imperfections in a circuit pattern.

An atmosphere of internal space 22 of a photomask 400 partitioned by the reticle 2, the frame 8, and the pellicle film 10 can be circulated by way of the opening 12. This prevents a change in the internal pressure of the space 22, which would otherwise arise when the frame 8 having the pellicle film 10 provided thereon is attached to the reticle 2. Accordingly, there can be prevented deformation of the pellicle film 10; that is, inflation and recession of the pellicle film 10, which would otherwise be caused by an atmospheric change. Further, since the internal atmosphere of the space 22 is circulated by way of the opening 12, the internal atmosphere of the space 22 is gradually replaced with an atmosphere in an area where the photomask 400 is to be stored. The filter 16 prevents intrusion of extraneous matter into the space 22 by way of the opening 12.

However, in order to address further miniaturization of a circuit pattern, such a process for transferring a pattern on a wafer through exposure requires an increase in the resolution of the exposure system. To this end, the wavelength of exposing radiation has gradually become shorter in the sequence of a mercury lamp (i-lines of 365 nm); KrF laser (248 nm); ArF laser (193 nm); and a F2 laser (157 nm).

As the wavelength of exposing radiation becomes shorter, absorption of exposing radiation by air and ionization of the oxygen existing in exposing radiation exert increasingly non-negligible influence. Hence, a wafer is exposed in a nitrogen atmosphere while an internal atmosphere of the exposure system is replaced with a nitrogen atmosphere.

When the photomask 400 is used as a mask pattern at the time of exposure, the atmosphere of the space 22 is gradually replaced with a nitrogen atmosphere in the exposure system by way of the opening 12. However, the opening 12 is equipped with the filter 16. Hence, complete replacement of the atmosphere of the space 22 with a nitrogen atmosphere of the exposure system involves consumption of a certain amount of time. In practice, a time which can reasonably be consumed for exposure is about 10 minutes or thereabouts. Difficulty is encountered in completely replacing the atmosphere of the space 22 within this period of time.

Accordingly, a wafer is exposed while air remains in the space 22. There may arise a case where residual air absorbs exposing radiation, thereby diminishing illumination at the time of exposure. When the residual air is excited by exposing radiation, damage is considered to be inflicted on the pellicle film 10 or the reticle 2. Hence, evacuation of residual air to the extent possible is preferable.

### SUMMARY OF THE INVENTION

Accordingly, the present invention proposes a photomask which is improved in structure so as not to leave residual air in an internal atmosphere thereof.

According to one aspect of the present invention, a photomask comprises a substrate having a pattern formed thereon, a pellicle which opposes a surface of the substrate and is stretched while being spaced a given interval from the surface, and a frame which retains the pellicle film and seals a space between the pellicle film and the photomask substrate. The frame includes an opening. The opening has a cover section capable of closing the opening.

Accordingly, an internal atmosphere of the space of the photomask can be sealed. Therefore, there can be prevented replacement of an internal atmosphere of the space with air. Accordingly, there can be prevented a situation such that air remains in the internal space of the photomask, thereby inhibiting absorption of exposing radiation by residual air or infliction of damage to the pellicle film or the reticle.

According to another aspect of the present invention, the photomask may further comprise pressure regulation means which regulates internal pressure of a space defined by the substrate, the pellicle film, and the frame.

Accordingly, there can be inhibited deformation of a pellicle film, which would otherwise be caused by a change in internal pressure of the space.

Other and further objects, features and advantages of the invention will appear more fully from the following description.

### BRIEF DESCRIPTION OF THE DRAWINGS

FIG. 1 is a schematic cross-sectional view showing a photomask according to a first embodiment of the invention;

FIG. 2 is an enlarged schematic cross-sectional view showing an area of the photomask shown in FIG. 1 in which a filter is provided;

FIGS. 3A and 3B are schematic cross-sectional views of an area of the photomask shown in FIG. 1 in which a pressure regulation film is provided;

FIG. 4 is a flowchart for describing a method of producing the photomask of the first embodiment of the invention;

FIG. 5 is a schematic cross-sectional view showing a photomask according to a third embodiment of the invention;

FIG. 6 is a schematic cross-sectional view showing a photomask to be used as an original plate at the time of transfer of a pattern onto a wafer.

### DETAILED DESCRIPTION OF THE PREFERRED EMBODIMENTS

Embodiments of the invention will be described hereinbelow by reference to the accompanying drawings. Throughout the drawings, like or corresponding elements are assigned identical reference numerals, and their repeated explanations are simplified or omitted.

First Embodiment

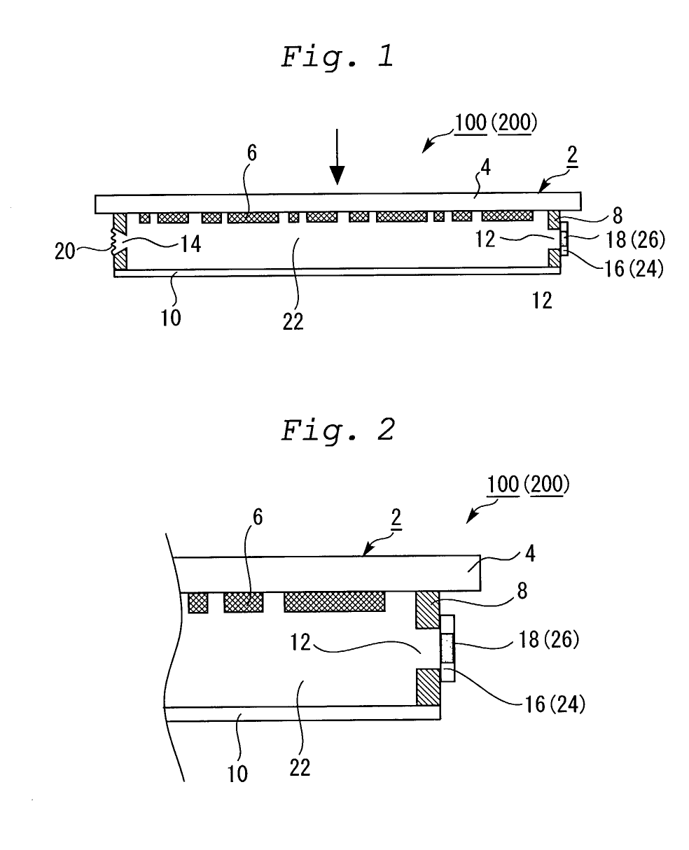

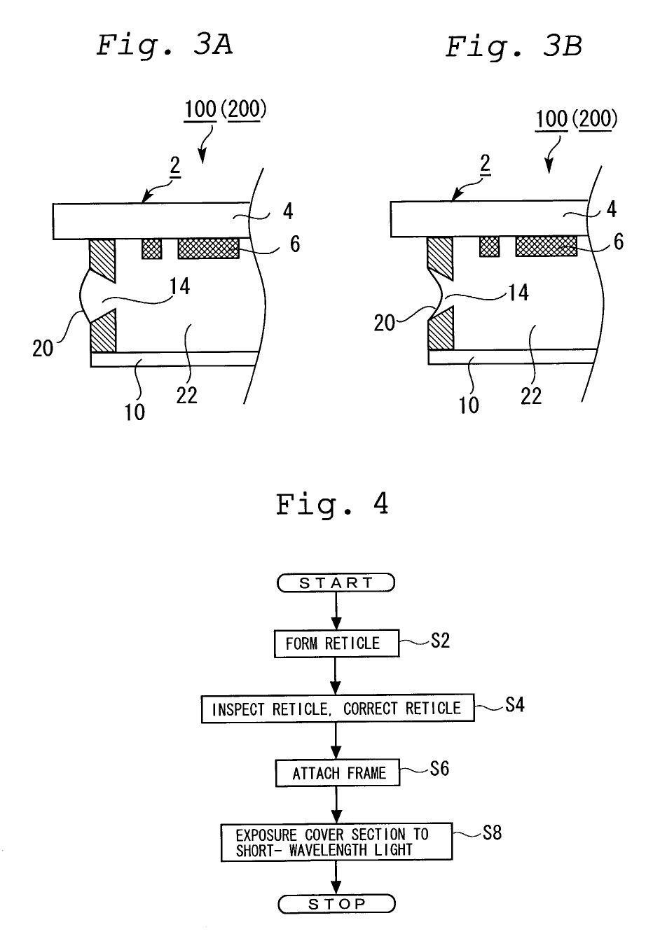

FIG. 1 is a schematic cross-sectional view showing a photomask 100 according to a first embodiment of the invention. FIG. 2 is an enlarged schematic cross-sectional view showing an area of the photomask 100 shown in FIG. 1 in which a filter is provided. FIGS. 3A and 3B are schematic cross-sectional views of an area of the photomask 100 shown in FIG. 1 in which a pressure regulation film is provided. FIG. 3A shows a case where the pressure of internal space of the photomask 100 is high, and FIG. 3B shows a case where the pressure of internal space of the photomask 100 is low.

As shown in FIG. 1, the photomask 100 has a reticle 2. The reticle 2 has a glass substrate 4 and chrome 6. The glass substrate 4 is a material which permits transmission of exposing radiation. The chrome 6 is material for interrupting exposing radiation. A pattern is formed on the reticle 2 by means of affixing the chrome 6 to the back of the glass substrate 4 so as to divide the reticle 2 into an area which permits transmission of exposing radiation and an area which does not permit transmission of exposing radiation.

A frame 8 is provided around the periphery of a surface of the reticle 2 on which the chrome 6 is affixed. The frame 8 stands at right angles to the glass substrate 4 to a height of 5 to 7 mm.

A pellicle film 10 is stretched across the frame 8 so as to oppose the surface of the reticle 2 having the chrome 6 affixed thereon. The pellicle film 10 is a thin film made of nitrocellulose.

Two openings 12, 14 are formed in the frame 8.

The opening 12 is equipped with a filter 16. The filter 16 is formed from material which is deteriorated upon exposure to short-wavelength light, such as UV rays or a laser beam. FIGS. 1 and 2 show that an area 18 of the filter 16 opposing the opening 12 is exposed, thereby closing the opening 12. In this state, the space 22 is sealed.

The opening 14 is equipped with a pressure regulation film 20. The pressure regulation film 20 is usually a thin film having irregularities. The thin film is made of a film which is thinner and softer than the pellicle film 10.

An atmosphere of the internal space 22 of the photomask 100 enclosed by the substrate 4, the frame 8, and the pellicle film 10 is replaced with an atmosphere of nitrogen gas.

Principal functions of the photomask 100 having such a structure will now be described.

The pellicle film 10 is provided for preventing adhesion of extraneous matter to the reticle 2.

The openings 12 and 14 are provided for regulating the internal pressure of the space 22 or replacing the atmosphere of the space 22 when the frame 8 having the pellicle film 10 provided thereon is affixed to the reticle 2.

As shown in FIG. 2, the filter 16 provided at the opening 12 enables intrusion of extraneous matter into the space 22. Upon exposure to short-wavelength light, such as UV rays or a laser beam, the filter 16 is deteriorated and fused, thereby closing the opening 12.

As shown in FIG. 3A, when the volume of an internal atmosphere of the space 22 is large and the pressure of the space 22 is high, the pressure regulation film 20 provided at the opening 14 inflates before the pellicle film 10 inflates and deforms, thereby resulting in a drop of internal pressure of the space 22. As shown in FIG. 3B, when the volume of an internal atmosphere of the space 22 is small and the pressure of the space 22 is low, the pressure regulation film 20 recedes before the pellicle film 10 recedes and is deformed, thereby increasing the internal pressure of the space 22. Thus, deformation of the pellicle film 10 can be prevented.

FIG. 4 is a flowchart for describing a method of producing the photomask 100 of the first embodiment.

A process for producing the photomask 100 will now be described by reference to FIG. 4.

First, the reticle 2 is produced (step S2).

Specifically, the reticle 2 is produced by means of affixing a film made of chrome 6 over the entire surface of the glass substrate 4, and patterning the chrome 6 by means of a lithography technique.

Subsequently, the reticle is subjected to inspection and, in the event imperfections are found, is subjected to correction (step S4). Here, the reticle is subjected to elaborate inspection with regard to whether or not a pattern is formed accurately; specifically, the reticle is inspected for appearance, dimensions, and positional accuracy. If correctable imperfections are found, the imperfections are corrected.

Next, the frame 8 on which the pellicle film 10 is stretched is affixed to the reticle 2 (step S6). Here, the frame 8 is affixed in an atmosphere of nitrogen gas. Accordingly, the internal space 22 of the photomask 100 is filled with a nitrogen gas.

The filter 16 is exposed to UV rays (step S8). Here, the area 18 of the filter 16 opposing the opening 12 is exposed to UV rays. The thus-exposed area 18 is deformed and fused, thereby closing the opening 12. Accordingly, the space 22 is sealed while being filled with nitrogen gas, and a gas existing outside the space 22 does not circulate into the space 22.

In this way, there is produced the photomask 100 in which the space 22 is filled with a nitrogen gas.

At this time, when the volume of nitrogen gas filling the space 22 is large and the internal pressure of the space 22 is high, the pressure regulation film 20 becomes inflated as shown in FIG. 3A. In contrast, when the volume of nitrogen gas filling the space 22 is small and the internal pressure of the space 22 is low, the pressure regulation film 20 recedes as shown in FIG. 3B. When the volume of nitrogen gas attains a predetermined level, the pressure regulation film 20 assumes an irregular shape, which is its usual shape. In this way, the internal pressure of the space 22 of the photomask 100 is regulated, and hence the pellicle film 10 is not subjected to deformation, such as inflation or recession, even when the space 22 is sealed.

As has been described, according to the first embodiment, the photomask 100 is produced in an atmosphere of nitrogen gas, and hence the space 22 can be filled with nitrogen gas. After the space 22 has been filled with nitrogen gas, the opening of the photomask 100 can be closed. Therefore, there can be prevented replacement of the nitrogen sealed in the space 22 with air, which would otherwise be caused during transportation of a photomask. Hence, there can be inhibited absorption of exposing radiation or infliction of damage to the pellicle film 10 or the reticle 2, which would otherwise be caused by residual air.

The opening 12 can be closed by means of merely exposing the filter 16 to short-wavelength light. Hence, the opening can be closed within a short period of time, thereby preventing consumption of excessive time, which would otherwise occur at the time of production of a photomask.

Even after the opening 12 has been closed, the internal pressure of the space 22 is regulated by means of presence of the pressure regulation film 20, which is thinner and softer than the pellicle film 10. There can be prevented deformation of the pellicle film 10, which would otherwise be caused by a change in the internal pressure of the space 22.

Thus far, description has been given of a case where the opening 12 is closed by means of deformation of a portion of the filter 16. However, the invention is not limited to this arrangement; the photomask may be provided with a closure which is deformed by means of exposing an exterior or interior of the filter 16 to short-wavelength light, to thereby close the opening 12. Here, the embodiment has been described such that UV rays are used as exposing radiation. However, the invention is not limited to the UV rays, and a laser beam or another short-wavelength light may alternatively be employed.

The filter 16 is made through use of a material which is deformed upon exposure to short-wavelength light. At the time of closing the opening 12, the filter 16 is exposed to short-wavelength light. However, the filter is not limited to the filter 16; a filter may be formed from material which is deformed under an arbitrary condition, in consideration of processing time. At the time of closing the opening 12, the condition is to be satisfied.

As means for regulating the internal pressure of the space 22, the pressure regulation film 20 provided at the opening 14 has been described. However, the means is not limited to the pressure regulation film 20; alternatively, there may be employed another means which regulates the internal pressure and inhibits deformation of the pellicle film 10. Moreover, the invention is not limited to a photomask having pressure regulation means.

The material of and method for making the reticle 2 and the material of the pellicle film are not limited to those described in connection with the first embodiment.

Processing pertaining to the process of affixing, to the reticle 2, the frame 8 having the pellicle film 10 described in connection with the first embodiment is performed in the atmosphere of nitrogen gas. However, the gas is not limited to a nitrogen gas; attachment of the frame 8 may be performed in an inactive gas (rare gas), such as helium, neon, or argon. Processing pertaining to this process may be performed with a machine which automatically attaches the frame 8 to the reticle, or may be performed manually.

Second Embodiment

A photomask 200 according to a second embodiment of the invention is structurally analogous to that shown in FIG. 1.

A filter 24 provided in the photomask 200 swells in an atmosphere gas or residual moisture in the space 22, thereby closing the opening 12.

Hence, even at the time of formation of the photomask 200, there are performed the steps of formation of the reticle 2 (step S2), inspection of the reticle 2 and correction of imperfections of the reticle 2 (step S4), and affixing of the frame 8 having the pellicle frame 10 to the reticle 2 (step S6), as in the case of the first embodiment. In an area 26 of the filter 24 which opposes the opening 12, the filter 24 swells upon contact with an atmosphere gas or residual moisture. Accordingly, as a certain period of time elapses, a gas flow passage is closed, thereby closing the opening 12.

In other respects, the second embodiment is identical with the first embodiment, and hence further explanation thereof is omitted.

As mentioned above, according to the second embodiment, the photomask 200 is made in an atmosphere of nitrogen gas. Hence, the space 22 can be filled with a nitrogen gas. Moreover, after the space 22 has been filled with a nitrogen gas, an opening 12 can be closed. Therefore, there can be prevented replacement of the atmosphere in the space 22 with air, which would otherwise be caused during transportation of a photomask. Accordingly, there can be prevented a situation such that oxygen remains in the internal space 22 of the photomask 200. Further, there can be inhibited absorption of exposing radiation by residual oxygen or infliction of damage to the pellicle film 10 or the reticle 2.

The opening 12 is closed when the filter 16 swells upon contact with a gas or moisture in the space 22. Accordingly, a necessity for imparting special energy for closing the opening 12 is obviated, thereby closing the opening by use of a more simple device.

After the opening 12 has been closed, the internal pressure of the space 22 is regulated, by means of the pressure regulation film 20, which is thinner and softer than the pellicle film 10. Hence, there can be prevented inhibited deformation of the pellicle film 10, which would otherwise be caused by a change in the internal pressure of the space 22.

The second embodiment has described that the filter 24 is deteriorated by the gas. However, the invention is not limited to the gas; there may also be employed, e.g., another material which is deformed by reaction with moisture.

Third Embodiment

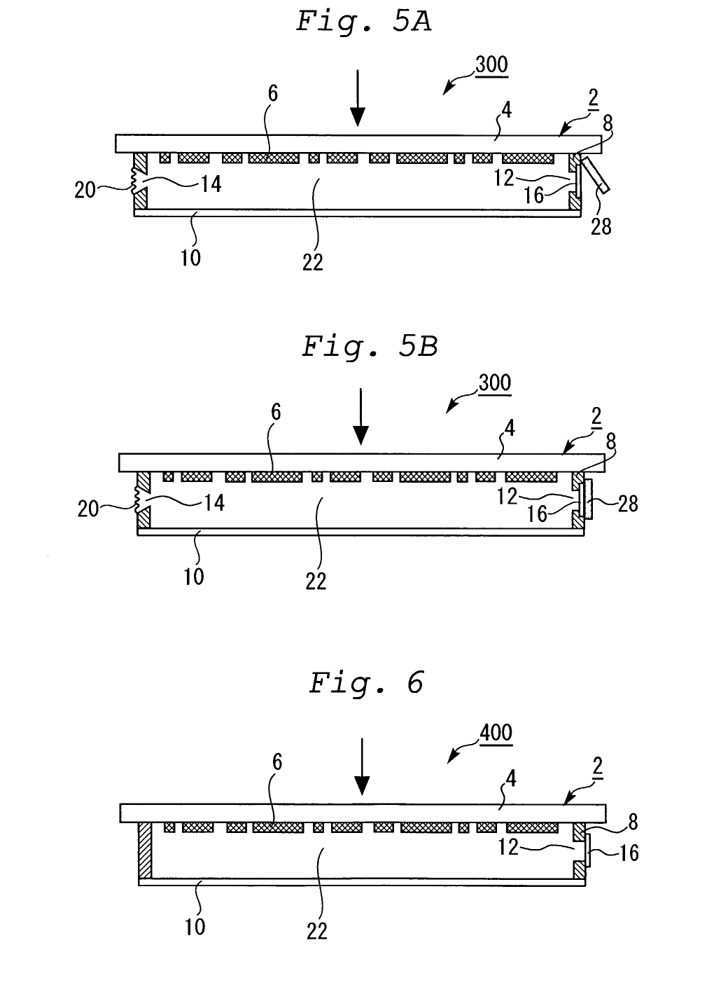

FIG. 5 is a schematic cross-sectional view showing a photomask according to a third embodiment of the invention. FIG. 5A shows an open state of a cover section 28, and FIG. 5B shows a closed state of the cover section 28.

A photomask 300 of the third embodiment is analogous to the photomasks 100 and 200 shown in FIG. 1.

As shown in FIG. 5, the opening 12 of the photomask 300 is provided with the filter 16. Another cover section 28 is provided on the filter 16. The cover section 28 is made of a shape memory alloy.

As shown in FIG. 5A, the cover section 28 is away from the filter 16 immediately after the frame 8 has been attached, and remains open. Therefore, an internal atmosphere of the space 22 can be circulated. When subjected to a certain degree of heat, the cover section 28 is deformed so as to close the opening 12 from above the filter 16, as shown in FIG. 5B.

Even at the time of formation of the photomask 300, there are performed the steps of formation of the reticle 2 (step S2), inspection of the reticle 2 and correction of imperfections of the reticle 2 (step S4), and affixing of the frame 8 having the pellicle frame 10 to the reticle 2 (step S6), as in the case of the first embodiment. Subsequently, the cover section 28 is exposed to infrared rays for heating purpose, to thereby become deformed and close the opening 12.

In other respects, the third embodiment is identical with the first and second embodiments, and hence further explanation thereof is omitted.

As mentioned above, according to the third embodiment, the photo mask 300 is made in an atmosphere of nitrogen gas. Hence, the space 22 can be filled with nitrogen gas. Moreover, after the space 22 has been filled with nitrogen gas, the opening 12 can be closed. Further, there can be prevented replacement of the atmosphere in the space 22 with air, which would otherwise be caused during transportation of a photomask. Accordingly, there can be prevented a situation such that oxygen remains in the internal space 22 of the photomask 300. Further, there can be inhibited absorption of exposing radiation by residual oxygen or infliction of damage to the pellicle film 10 or the reticle 2.

The opening 12 can be closed by means of merely exposing the cover section 28 to infrared rays. Hence, the opening can be closed within a short period of time. Production of a photomask does not entail consumption of a needless time.

In the third embodiment, the cover section 28 is heated. To this end, the cover section 28 is exposed to infrared rays. However, exposing radiation is not limited to infrared rays; the cover section may be heated by means of exposure to a laser beam or by another method.

The third embodiment has described a case where the cover section 28 is produced from a shape memory alloy and where the opening 12 can be closed by application of heating. However, the cover section 28 is not limited to this embodiment. For instance, an adhesive tape which can be affixed to the filter 16 from above may also be employed as a cover section, or the cover section may be closed by another method.

In relation to the invention, a substrate having a pattern formed thereon corresponds to, e.g., the reticle 2 described in connection with the first through third embodiments. For instance, the filter 16 described in connection with the first embodiment 1, the filter 24 described in connection with the second embodiment, and the cover section 28 described in connection with the third embodiment correspond to the cover section of the invention. Moreover, a pressure regulation mechanism of the invention corresponds to, e.g., the pressure regulation film 20 described in connection with the first through third embodiments.

In relation to the first through third embodiments, processing pertaining to a pattern formation step of the invention is performed by means of executing processing pertaining to step 2. For example, processing pertaining to a frame attachment step of the invention is performed by means of executing processing pertaining to step S6. For example, processing pertaining to a sealing step of the invention is performed by means of executing processing pertaining to step S8 of the first through third embodiments.

The features and the advantages of the present invention as described above may be summarized as follows.

According to one aspect of the present invention, a photomask is produced in an atmosphere of inactive gas, and hence a space can be filled with an inactive gas. Moreover, after the space has been filled with a nitrogen gas, the opening of the photomask can be closed. Accordingly, an internal atmosphere of the space of the photomask can be sealed. Therefore, there can be prevented replacement of an internal atmosphere of the space with air. Accordingly, there can be prevented a situation such that air remains in the internal space of the photomask, thereby inhibiting absorption of exposing radiation by residual air or infliction of damage to the pellicle film or the reticle.

In another aspect, in a photomask whose opening may be closed upon mere exposure to short-wavelength light or a photomask whose opening may be closed by heating, the opening can be closed within a short period of time. Accordingly, production of a photomask does not entail consumption of needless time. Further, a timing at which an opening is to be closed can be set arbitrarily, and hence the opening can be closed at an appropriate timing without involvement of residual air. Therefore, the photomask is effective.

In another aspect, in a photomask, the opening may be closed by means of a member swelling in response to contact with an internal gas or moisture. Accordingly, the opening can be closed with use of a more simple mechanism. Hence, a manufacturing time or the like can be shortened.

In another aspect, in a photomask having pressure regulation means, internal pressure of the space can be regulated even after an opening has been closed. Accordingly, there can be inhibited deformation of a pellicle film, which would otherwise be caused by a change in internal pressure of the space.

Obviously many modifications and variations of the present invention are possible in the light of the above teachings. It is therefore to be understood that within the scope of the appended claims the invention may by practiced otherwise than as specifically described.

The entire disclosure of a Japanese Patent Application No. 2002-119561, filed on Apr. 22, 2002 including specification, claims, drawings and summary, on which the Convention priority of the present application is based, are incorporated herein by reference in its entirety.

What is claimed is:

1. A photomask comprising:
a substrate having a pattern formed thereon;
a pellicle which opposes a surface of the substrate and is stretched while being spaced a given interval from the surface; and
a frame which retains the pellicle film and seals a space between the pellicle film and the photomask substrate, wherein
the frame includes an opening; and
the opening has a cover section capable of closing the opening.

2. The photomask according to claim 1, wherein the cover section is deformed upon exposure to short-wavelength light, thereby closing the opening.

3. The photomask according to claim 1, wherein the cover section swells up on contact with a gas or moisture, thereby closing the opening.

4. The photomask according to claim 1, wherein the closure section is a filter provided at the opening.

5. The photomask according to claim 1, wherein the closure section is a shape memory alloy and closes the opening when heated to a predetermined temperature.

6. The photomask according to claim 1, wherein the cover section is an adhesive tape and closes an opening when affixed to the opening from above.

7. The photomask according to any one of claims 1 through 6, further comprising pressure regulation means for regulating internal pressure of a space defined by the substrate, the pellicle film, and the frame.

8. The photomask according to claim 7, wherein
the frame has two openings;
the cover section is provided at one of the two openings; and
the pressure regulation means has a thin film provided at the other opening.

9. The photomask according to claim 1, wherein the space defined by the substrate, the pellicle film, and the frame is filled with an inactive gas.

10. The photomask according to claim 9, wherein the inactive gas is a nitrogen gas.
